(19) United States
(12) Patent Application Publication
(10) Pub. No.: US 2009/0166428 A1
(43) Pub. Date: Jul. 2, 2009

(54) METHODS AND APPARATUS FOR USE IN ASSOCIATION WITH MEDIA

(76) Inventors: Simon Phillips, York (GB); James J. Anderson, Natick, MA (US)

Correspondence Address: BUCKLEY, MASCHOFF & TALWALKAR LLC, 50 LOCUST AVENUE, NEW CANAAN, CT, 06840, US

(21) Appl. No.: 11/966,108

(22) Filed: Dec. 28, 2007

(51) Int. Cl. G06K 19/00

(52) U.S. Cl. 235/487

(57) ABSTRACT

According to some embodiments, a method comprises providing a media including a plurality of coupled pages, the plurality of coupled pages including at least one printed page defined by at least one printed sheet; coupling at least one RF identification token to the at least one printed sheet; and storing information in the at least one RF identification token, the information including information regarding a plurality of products. According to some embodiments, apparatus comprises a media including a plurality of coupled pages, the plurality of coupled pages including at least one printed page defined by at least one printed sheet; and at least one RF identification token coupled to the at least one printed sheet, the at least one RF identification token including stored information regarding a plurality of products.

### BACKGROUND

Print media is in widespread use. Examples include newspapers, magazines and catalogues. Such media often include advertisements printed therein. The advertisements often include contact information that indicates how to make a purchase and/or obtain further information. Such contact information often includes the name of a person, a telephone number and/or a uniform resource locator (URL) for an Internet website.

In some situations, a person may use the contact information to make a telephone call and/or to go online to view an Internet website to obtain further information and/or make a purchase.

### BRIEF DESCRIPTION OF THE DRAWINGS

FIG. 1 is a perspective view of a media, according to some embodiments;

FIG. 2 is a schematic block diagram of an RF identification token, according to some embodiments;

FIG. 3 is a schematic plan view of an RF identification token, according to some embodiments;

FIG. 4A is a schematic block diagram of a communication device, according to some embodiments;

FIG. 4B is a schematic block diagram of a subsystem, according to some embodiments;

FIG. 4C is a schematic rear perspective view of a communication device, according to some embodiments;

FIG. 5 is a schematic front perspective view of a communication device; according to some embodiments;

FIG. 6 is a schematic perspective view of a media and communication device; according to some embodiments;

FIG. 7 is a schematic view of a portion of a first communication device and a second communication device, according to some embodiments;

FIG. 8 is a flow chart of a method, according to some embodiments;

FIG. 9 is a flow chart of a method, according to some embodiments;

FIG. 10 shows a method for use in coupling at least one identification token to a sheet, according to some embodiments;

FIG. 11 shows a method for use in coupling at least one identification token to a sheet, according to some embodiments;

FIG. 12 is a perspective view of a media, according to some embodiments;

FIG. 13 is a perspective view of a media, according to some embodiments;

FIG. 14 is a perspective, partially broken away view of a media, according to some embodiments;

FIG. 15 is a block diagram of an apparatus, according to some embodiments.

### DETAILED DESCRIPTION

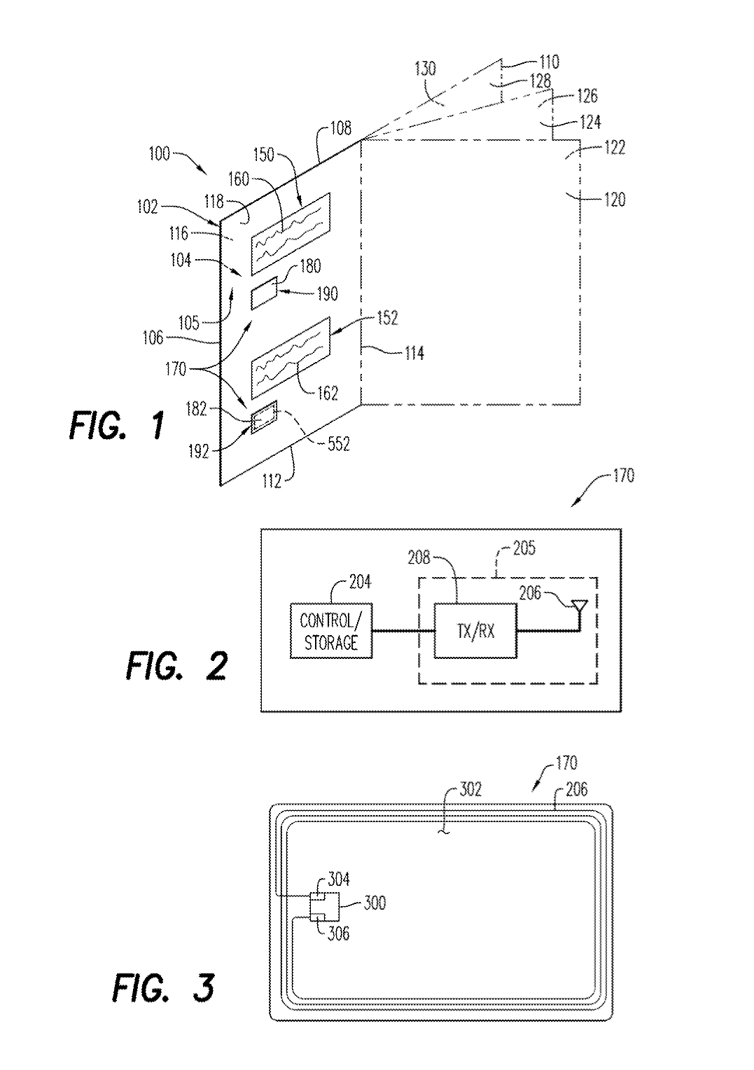

FIG. 1 is a perspective view of a media in accordance with some embodiments. Unless stated otherwise, a media may comprise a brochure, a menu, a magazine, a newspaper, a catalogue, a book and/or any other type of media or combination thereof.

Referring to FIG. 1, in accordance with some embodiments, a media 100 includes at least one sheet 102. Each of the at least one sheet 102 may have any configuration. In some embodiments, each of the at least one sheet 102 has a generally uniform thickness and a generally rectangular configuration that includes a first side 104, a second side 105, a first edge 106, a second edge 108, a third edge 110 and a fourth edge 112. The first edge 106 may be parallel to the third edge 110. The second edge 108 may be parallel to the fourth edge 112. The second edge 108 and the fourth edge 112 may be perpendicular to the first edge 106 and the third edge 110. In some embodiments, each of the at least one sheet 102 further includes a fold 114. In some embodiments, each of the at least one sheet 102 comprises paper and/or other flexible material(s).

If the at least one sheet 102 comprises more than one sheet, such sheets may be fixedly and/or loosely coupled to one another. In some embodiments, sheets are fixedly coupled using adhesive and/or fasteners. In some embodiments, sheets are loosely coupled by folding one or more of the sheets to define a pocket that receives one or more other sheet (which may or may not also be folded).

The at least one sheet 102 may define a plurality of pages. In the illustrated embodiment, for example, the at least one sheet 102 defines a first page 116, a second page 118, a third page 120, a fourth page 122, a fifth page 124, a sixth page 126, a seventh page 128 and an eighth page 130. In particular, one sheet 102 defines pages 116, 118, 128 and 130. Notably, page 116 is defined by side 104, edges 106, 108, 112 and fold 114. Page 130 is defined by side 105, edges 108, 110, 112 and fold 114. The other sheet 102 defines pages 120, 122, 124 and 126.

In accordance with some embodiments, the plurality of pages may be fixedly and/or loosely coupled to one another. In the illustrated embodiment, for example, pages 116, 118, 128 and 130 are fixedly and/or loosely coupled to pages 120, 122, 124, 104, 105 and 106. Notably, pages 116 118, 128 and 130 are also fixedly coupled to one another.

The plurality of pages may define a plurality of printed regions. In the illustrated embodiment, for example, the plurality of printed regions includes a first printed region 150 and a second printed region 152. The first printed region 150 may include first printing 160. The second printed region 152 may include second printing 162.

The printing may be provided in any manner and may comprise any type of indicia. Unless stated otherwise, indicia may comprise letters, words, symbols, designs, graphics, images, and/or any other type of indicia. A sheet that includes any amount of printing is referred to herein as a printed sheet. A page that includes any amount of printing is referred to herein as a printed page.

In some embodiments, the first printed region 150 includes an advertisement and/or other information regarding a first product. The second printed region 152 may include an advertisement and/or other information regarding a second product.

Unless stated otherwise, a product may comprise but is not limited any type of goods and/or services. In some embodiments, a product may be offered for sale, rent and/or lease.

In some embodiments, the media 100 comprises a magazine, newspaper, catalogue and/or brochure and the plurality of products comprise items advertised in the magazine, newspaper, catalogue and/or brochure. In some embodiments, the media 100 comprises a menu for an eating establishment and the products comprise items on the menu.

The media 100 further includes at least one RF identification token 170 coupled to the at least one sheet 102. In some embodiments, the at least one RF identification token 170 includes a first RF identification token 180 and a second RF identification token 182. The first RF identification token 180 may be disposed at a first position 190. The second RF identification token 182 may be disposed at a second position 192.

In accordance with some embodiments, the at least one RF identification token 170 includes information regarding a plurality of products. In some embodiments, the first RF identification token 180 includes information regarding the first product. Such information may include information not included in the first printed region 150. The second RF identification token 182 may include information regarding the second product. The information may include information not included in the second printed region 152.

In accordance with some embodiments, and as further described below, a person may use a reader and/or other type of communication device to access one or more portions of the information in the at least RF identification token 170. Thus, in some embodiments, a person may not need to make a telephone call and/or visit an Internet website to obtain further information.

In some embodiments, the at least one RF identification token 170 comprise at least 100 k bytes of information regarding the plurality of products. In some embodiments, each of the at least one RF identification token 170 comprises at least 100 k bytes of information regarding at least one of the plurality of products. In some embodiments, the at least one RF identification token 170 comprise at least IM bytes of information regarding the plurality of products. In some embodiments, each of the at least one RF identification token 170 comprises at least IM bytes of information regarding at least one of the plurality of products.

FIG. 2 is a schematic block diagram of one of the at least one RF identification token 170, according to some embodiments. Referring to FIG. 2, in some embodiments, the identification token 170 includes control/storage circuitry 204 and a wireless communication interface 205.

The control/storage circuitry 204 is operative to store information to be transmitted to a reader. In some embodiments, the information comprises information regarding at least one product. In some embodiments, the information comprises information that may be used to uniquely identify a product for purchase. In some embodiments, the control/storage circuitry 204 may comprise a simple memory device capable only of responding to a pre-defined set of commands. In some other embodiments, the control/storage circuitry 204 may comprise a secure microcontroller capable of executing a pre-defined program.

The wireless communication interface 205 allows the identification token 102 to transmit and/or receive signals. The signals transmitted by the wireless communication interface 205 may include a information stored in the control/storage circuitry 204. In some embodiments, the signals received by the wireless communication interface may include an interrogation signal, a power signal and/or other signals. In some embodiments, the interrogation signal may be similar to an interrogation signal used in a well known standard for proximity payment devices promulgated by MasterCard International Incorporated, the assignee hereof, and is referred to as “PayPass”.

In some embodiments, wireless communication interface 205 comprises an antenna 206 and transmit/receive circuitry 208. The antenna 206 may be configured to transmit and receive radio frequency (RF) signals and may comprise a loop antenna and/or any other suitable configuration. The transmit/receive circuitry 208 may be coupled between the antenna 206 and the control/storage circuitry 204.

In operation, wireless signals (e.g., RF signals) may be received by the antenna 206 and supplied to the transmit/receive circuitry 208, which in response may provide signals that are supplied to the control/storage circuitry 204. The control/storage circuitry 204 may also provide signals that are supplied to the transmit/receive circuitry 208, which in response may provide signals that are supplied to the antenna 206 and transmitted thereby.

In some embodiments, the control/storage circuit 204 and the transmit/receive circuitry 208 are disposed in a single integrated circuit. In some embodiments, the control/storage circuitry 204 and the transmit/receive circuitry 208 are disposed in an RFID IC. Unless stated otherwise, the term RFID is not limited to a specific type of RFID. In some embodiments, an RFID may be a simple memory device capable only of responding to a pre-defined set of commands. In some other embodiments, an RFID may comprise a microcontroller capable of executing a program. Some embodiments may include further features. Some embodiments may comprise other configurations altogether. In some embodiments, the RFID IC comprises an IC that uses contactless technology, such as, for example, as specified in international standard ISO/IEC 14443.

FIG. 3 is a schematic plan view of one of the at least one RF identification token 170, in accordance with some embodiments. Referring to FIG. 3, in accordance with some embodiments, the RF identification token comprises the antenna 206 and an RFID IC 300. The RFID IC 300 may include the control/storage circuitry 204 (FIG. 2) and the transmit/receive circuitry 208 (FIG. 2). The antenna 206 and the RFID IC 300 may be supported by a carrier 302. Unless stated otherwise, the term “supported by” means partially and/or entirely disposed on, disposed in, mounted on, mounted in, installed on, installed in, contained in and/or embedded in.

The RFID IC 300 may include contact pads 302, 304. The antenna 206 may be coupled to the transmit/receive circuitry 208 (FIG. 2) via such contact pads 302, 304.

As shown, the antenna 206 may be in the form of several loops arranged in and/or supported on the carrier 302. Alternatively, the antenna 506 may be of a different type and/or configuration.

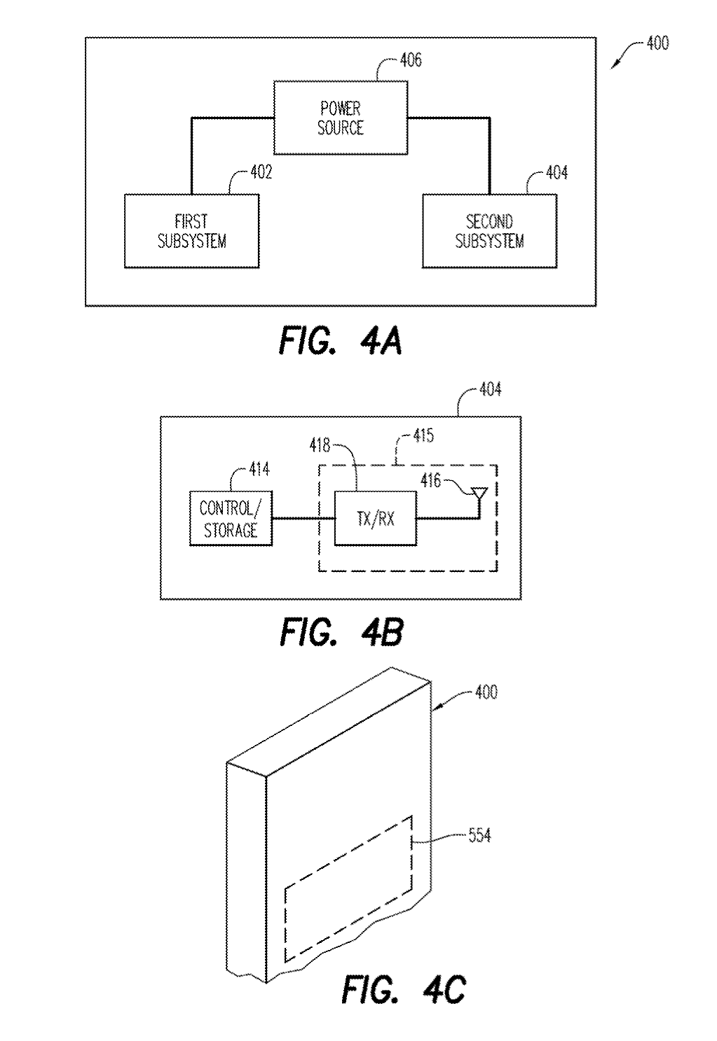

FIG. 4A is a schematic block diagram of a communication device 400 to transmit and/or receive information to and/or from the at least one RF identification token 170, in accordance with some embodiments.

Referring to FIG. 4A, in accordance with some embodiments, a communication device 400 to transmit and/or receive information to/from the at least one RF identification token 170 may comprise a cell phone, a music player, a video player, a personal digital assistant (PDA), a wristwatch, and/or any other type of consumer or portable device.

In accordance with some embodiments, the communication device 400 includes first and second subsystems 402, 404. If the device 400 comprises a cell phone, the first subsystem 402 may include circuitry and/or other components to perform wireless communication with a cellular network. If the device 400 comprises a music player, the first subsystem 402 may comprise circuitry and/or other components to play music. If the device 400 comprises a video player, the first subsystem 402 may comprise circuitry and/or other components to play video (with or without associated audio). If the device 400 comprises a PDA, the first subsystem 402 may comprise circuitry and/or other components to perform one or more functions of the PDA. If the device 400 comprises a wristwatch, the first subsystem 402 may comprise circuitry and/or other components to perform one or more functions of the wristwatch.

The second subsystem 404 may include circuitry and/or other components to perform near field communication.

Although the first subsystem 402 is shown separate from the second subsystem 404, in some embodiments, the first subsystem 402 and the second subsystem 404 may share one or more circuits and/or components.

The communication device may further include a power source 406. The power source 406 may be coupled (directly and/or indirectly) and/or supply power (directly and/or indirectly) to the first subsystem 402 and/or the second subsystem 404. In some embodiments, the power source 406 comprises a battery.

FIG. 4B is a schematic block diagram of the second subsystem 404, according to some embodiments. Referring to FIG. 4B, in accordance with some embodiments, the second subsystem 404 includes control/storage circuitry 414 and a wireless communication interface 415.

In some embodiments, the control/storage circuitry 414 may be a simple memory device capable only of responding to a pre-defined set of commands. In some other embodiments, the control/storage circuitry 414 may comprise a secure microcontroller capable of executing a pre-defined program.

The wireless communication interface 415 facilitates wireless communication with the at least one RF identification token 170. In some embodiments, wireless communication interface 415 comprises an antenna 416 and transmit/receive circuitry 418. The antenna 416 may be configured to transmit and receive radio frequency (RF) signals and may comprise a loop antenna and/or any other suitable configuration. The transmit/receive circuitry 418 may couple the antenna 416 to the control/storage circuitry 414.

In some embodiments, the control/storage circuit 414 and the transmit/receive circuitry 418 are disposed in a single integrated circuit. In some embodiments, the control/storage circuit 414 and the transmit/receive circuitry 418 are disposed in an IC that uses NFC technology, such as, for example, an NFC IC provided by PHILIPS ELECTRONICS or NXP Semiconductors.

In operation, wireless signals (e.g., RF signals) are received by the antenna 416 and supplied to the transmit/receive circuitry 418, which in response may provide signals that are supplied to the control/storage circuitry 414. The control/storage circuitry 414 may also provide signals that are supplied to the transmit/receive circuitry 418, which in response, may provide signals that are supplied to the antenna 416 and transmitted thereby.

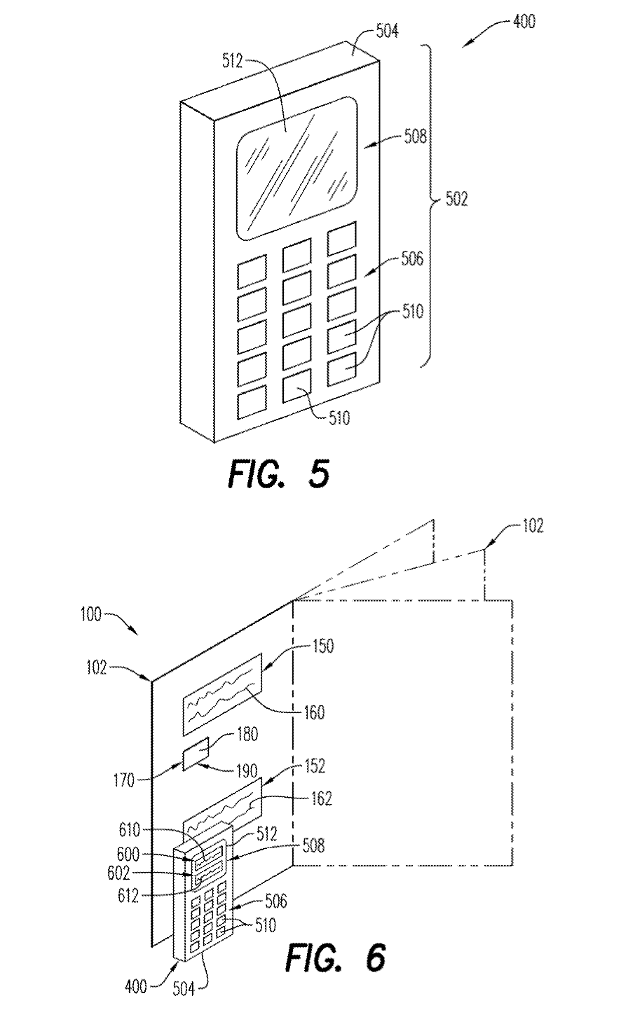

FIG. 5 is a schematic perspective view of the communication device 400, in accordance with some embodiments. Referring to FIG. 5, in accordance with some embodiments, the communication device 400 may comprise a user interface 502 supported by a body 504.

The user interface 502 may comprise at least one input device 506 and/or at least one output device 508. The at least one input device 506 may comprise a key pad having a plurality of keys 510. The at least one output device 508 may comprise a display 512.

FIG. 6 is a schematic perspective view of the media 100 and the communication device 400, in accordance with some embodiments.

Referring to FIG. 6, in some embodiments, the communication device 400 may be used to access one or more portions of the information in the at least one RF identification token 170. In some embodiments, this may include presenting one RF identification token 182 (FIG. 1) to the communication device 400. In some embodiments, this may include positioning the media 100 and/or the communication device 400 such the RF identification token 182 is within wireless communication range of the communication device 400 and/or in physical contact with the communication device 400.

In some embodiments, the at least one RF identification token 170 is not visible to persons looking at the media 100 and/or not recognizable by persons looking at the media 100.

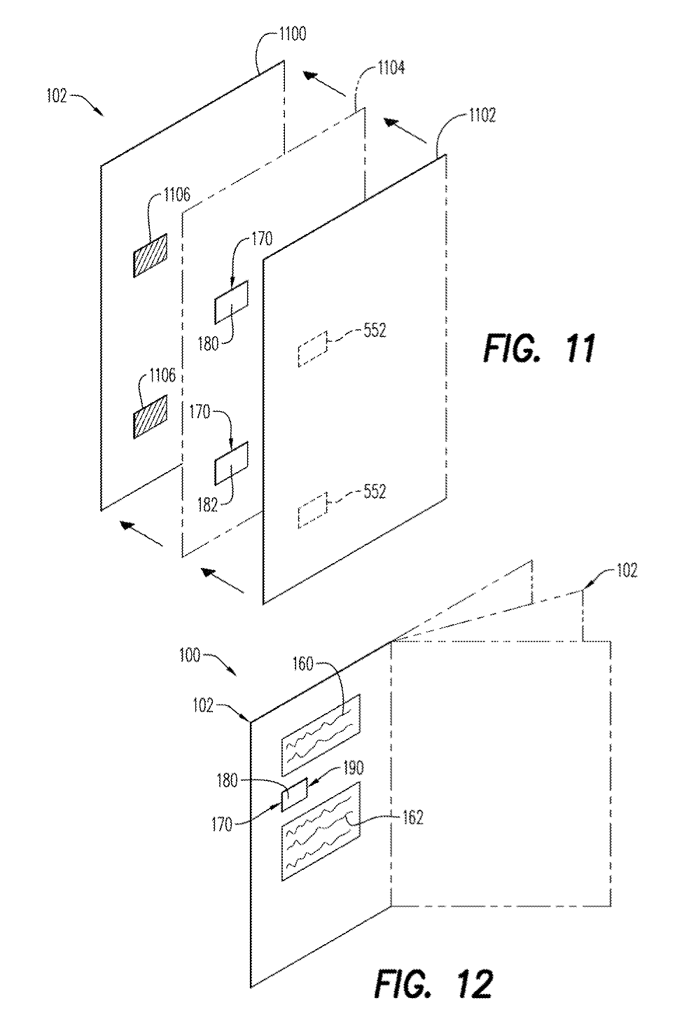

In some embodiments, at least one indicia 552 (FIG. 1, FIG. 11) is provided on the media 100 and/or on the at least one RF identification token 170 to inform persons as to the position of each of the at least one RF identification token 170. In some embodiments, each of the at least one indicia is associated with a respective one of the at least one RF identification token 170 and may comprise a line (solid or broken) that indicates the location of the antenna 206 (FIGS. 2-3) of the associated RF identification token 170. In some embodiments, in addition or in lieu thereof, each of the at least one indicia may comprise text with instructions such as for example, “PLACE READER HERE”.

In the illustrated embodiment, the antenna 416 (FIG. 4B) may be disposed, for example, slightly above the middle of the back of the reader or other type of communication device 400. In some embodiments, an indicia 554 (FIG. 4C) is provided on the communication device 400 to inform persons using the communication device 400 as to the position of the antenna 416 (FIG. 4B). In some embodiments, such indicia may comprise a line (solid or broken) that indicates the location of the antenna 416 (FIG. 4B) of the communication device 400. In some embodiments, in addition or in lieu thereof, the indicia may comprise text with instructions such as for example, “PLACE OVER RF TOKEN”.

The communication device 400 may recognize the RF identification token 182, and may transmit a signal to the RF identification token 182. The RF identification token 182 may receive the signal, which may cause the RF identification token 182 to be powered up. The RF identification token 182 may transmit one or more portions of the information stored therein. The communication device 400 may receive the information and may supply one or more portions of the information to the display 512.

In the illustrated embodiment, for example, the display 512 includes a first region 600 and a second region 602. The first region 600 includes first information 610. The second region 602 includes second information 612. The first information 610 may comprise information regarding a first product. In some embodiments, the second information 612 may also comprise information regarding the first product. In some embodiments, the second information 612 may comprise information regarding a second product.

In accordance with some embodiments, the first information 610 and the second information 612 comprise information not included on the at least one sheet 102.

In some embodiments, the user may use the user interface 502 of the communication device 400 to scroll through the information received from the RF identification token 182. In some embodiments, the user instructs the communication device 400 to transmit a request for additional information. The RF identification token may receive the request and may transmit additional information to the communication device 400 in response thereto.

In some embodiments, the communication device 400 may store one or more portions of the data for subsequent reference, ordering and/or purchasing one or more of the plurality of products.

Thus, in accordance with some embodiments, a person may use a communication device 400 to access one or more portions of the information in the at least RF identification token.

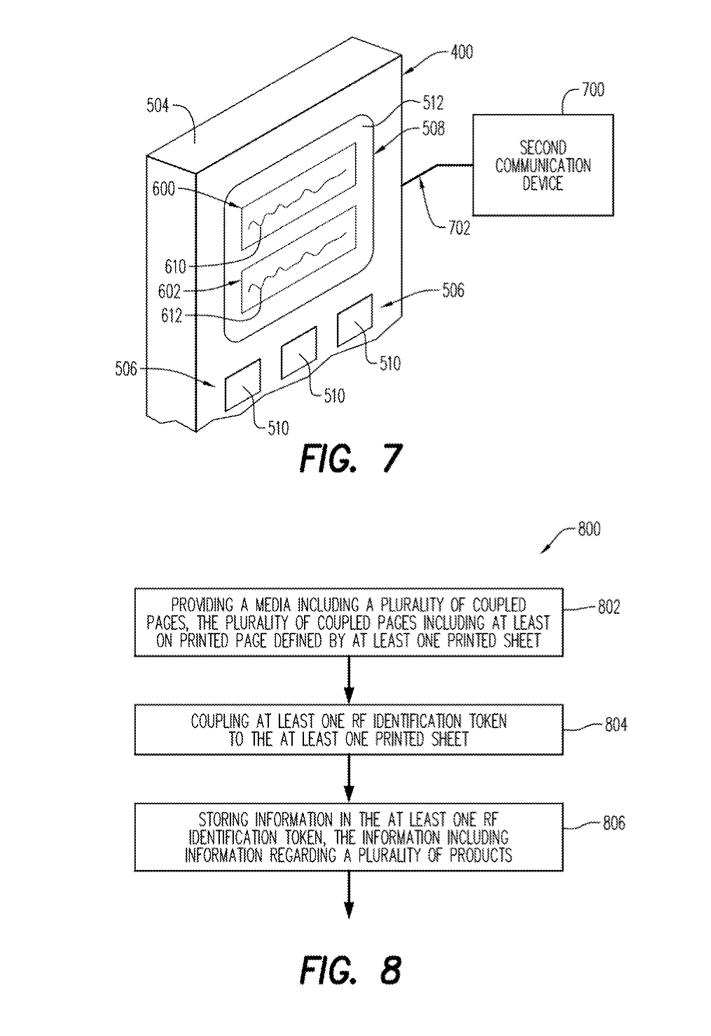

FIG. 7 is a schematic view of a portion of the communication device 400 and a second communication device 700, according to some embodiments. Referring to FIG. 7, the communication device 400 may be coupled to a second communication device 700 by a communication link 702.

Unless stated otherwise, a communication link may comprise any type of communication link, for example, but not limited to wired (e.g., conductors, fiber optic cables) or wireless (e.g., acoustic links, electromagnetic links or any combination thereof including, for example, but not limited to microwave links, satellite links, infrared links), and/or any combinations thereof. A communication link may be public or private, dedicated and/or shared (e.g., a network) and/or any combination thereof. A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

In some embodiments, the information from the at least one RF identification token 170 may include information that the communication device 400 may use to communication and/or open a channel with the second device 700. In some embodiments, such information may comprise a telephone number and/or a URL for an Internet website.

In some embodiments, the second communication device 700 comprises a device operated by and/or on behalf of at least one of: a supplier of at least one of the plurality of products; and a party associated with the supplier of at least one of the plurality of products. In some embodiments, the second communication device 700 comprises a server. In some embodiments the device comprises a device coupled to a payment server. In some embodiments, the device comprises a server operating a website. In some embodiments, the device comprises a server coupled to a telephone network and/or the Internet.

In some embodiments, the second communication device 700 comprises a device to receive requests for additional information regarding at least one of the plurality of products. In some embodiments, the second communication device comprises a device to receive orders and/or purchase requests. In that regard, in some embodiments, the media 100 comprises a magazine, newspaper, catalogue and/or brochure and device comprises a server for taking orders and/or purchasing items advertised in the magazine, newspaper, catalogue and/or brochure. In some embodiments, the media 100 comprises a menu for an eating establishment and the second communication device 700 comprises a server for taking orders for items (e.g., food and/or beverages) on the menu.

In some embodiments, the communication device 400 may transmit information to the second communication device 700. In some embodiments, the information may comprise at least a portion of the information transmitted from the at least one RF identification token. In some embodiments, the information transmitted from the communication device comprises at least one of: an identification of a product, a name of a person, contact information for a person, and an account number.

If the communication device comprises a cell phone and/or other device coupled to a cellular network, the communication device may transmit the information via a communication link that includes the cellular network.

In some embodiments, the communication device 400 may transmit the information using at least one of: a telephone network; and a computer network.

In some embodiments, the information comprises an attempted order and/or purchase of at least one of the plurality of products. In some embodiments, the information may identify at least one product. In some embodiments, the information may include a payment account number. In some embodiments, the communication device may determine whether the attempted order and/or purchase was successful. If the attempted order and/or purchase was not successful, the communication device may inform the user that the attempted order and/or purchase was not successful. If the attempted order and/or purchase was successful, the communication device may inform the user that the attempted order and/or purchase was successful.

Thus, in some embodiments, a person may use a reader and/or other type of communication device to access information from other devices, to place an order and/or to make a purchase.

FIG. 8 is a flow chart 800 of a method according to some embodiments. In some embodiments, one or more portions of the method may be used in association with the media 100, the at least one RF identification token 170 and/or the communication device 400. In some embodiments, one or more portions of the method may be used in association with one or more portions of the method of FIG. 8. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method.

Referring to FIG. 8, at 802, the method may include providing a media that includes a plurality of coupled pages. The plurality of coupled pages may include at least one printed page defined by at least one printed sheet.

At 804, the method may further include coupling at least one RF identification token to the at least one printed sheet.

At 806, the method may further include storing information in the at least one RF identification token. The information stored in the at least one RF identification token may include information regarding a plurality of products.

The information may be stored in the identification token before, during and/or after coupling the at least one RF identification token to the at least one sheet. Moreover, as stated above, the information to be printed on the at least one sheet may be printed before during and/or after coupling the at least one RF identification token to the at least one sheet.

In some embodiments, one or more portions of the method may be carried out using methods that are similar to those used in the course of personalization and/or a pre-personalization of proximity payment devices. This may include coupling the at least one identification token to at least one sheet and supplying the at least one sheet, with the at least one identification token coupled thereto, to contactless programming equipment. The equipment may store information regarding the plurality of products in the at least one identification token. In some embodiments, this may include storing information regarding a plurality of products in a single RF identification token. In some embodiments, this may include storing information in a first RF identification token and storing different information in a second RF identification token. The information stored in the first RF identification token may describe a first product. The information stored in the second RF identification token may describe a second product. Other information may also be stored in the at least one identification token. In some embodiments, the information is stored in control/storage circuitry 204 (FIG. 2) of the identification token.

In some embodiments, the contactless programming equipment also prints information on the at least one sheet. This information may include information regarding the plurality of products.

In some embodiments, some or all of the information to be printed on the at least one sheet is printed before supplying the at least one sheet to the contactless programming equipment and/or after removing the at least one sheet from the contactless programming equipment.

In some embodiments, multiple sheets and identification tokens are processed as a batch, and the information transmitted to each identification token and/or information printed on each sheet may be the same for all sheets and all identification tokens in the batch. In some other embodiments, multiple sheets and identification tokens are processed as a batch, and the information transmitted to each identification token and/or information printed on each sheet may not be the same for all sheets and all identification tokens in the batch.

In some embodiments, information may be stored in the at least one identification token before coupling the at least one identification token to the at least one sheet. In some embodiments, the at least one identification token may be releasably retained to at least one carrier to facilitate handling by contactless programming equipment. The at least one carrier, with the at least one identification token releasably retained thereto, may be supplied to contactless programming equipment. The equipment may store information regarding the plurality of products in the at least one identification token. This may include one or more of the methods described above. After the information is stored in the at least one identification token, the at least one identification token may be separated from the holder. The at least one identification may thereafter be coupled to the at least one sheet.

The method may further include supplying the media to a customer. Unless stated otherwise, the term “supplying” may include, but is not limited to, giving, loaning, renting, selling, transferring, sending, delivering, mailing and/or handing the media to the customer. Also, unless stated otherwise a customer may include but is not limited to a previous customer, a current customer, a future customer and/or a prospective customer.

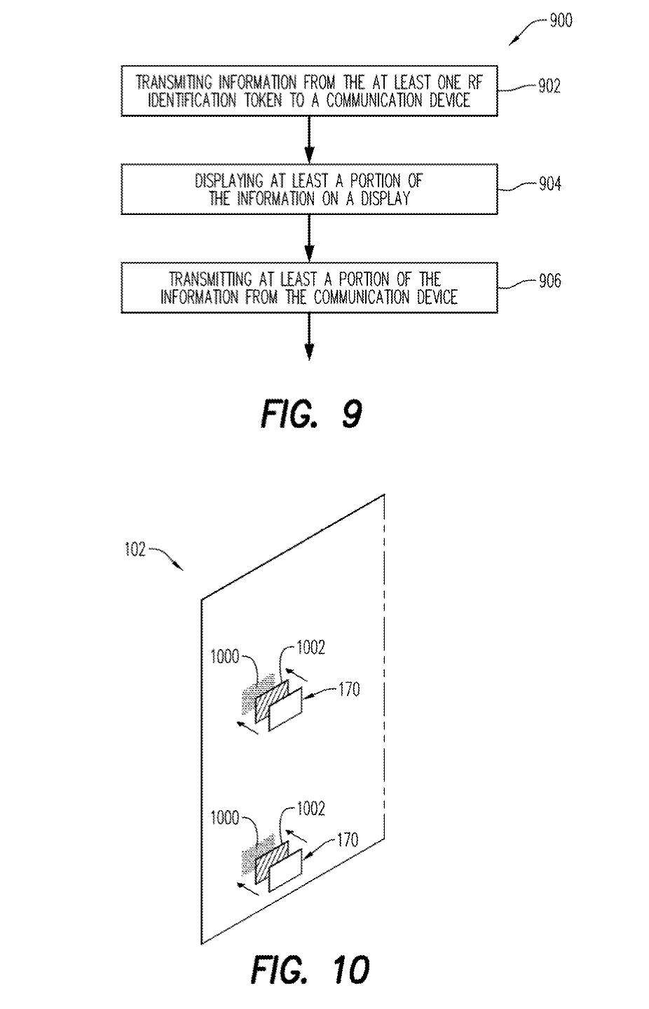

FIG. 9 is a flow chart 900 of a method according to some embodiments. In some embodiments, one or more portions of the method may be used in association with the media 100, the at least one RF identification token 170 and/or the communication device 400. In some embodiments, one or more portions of the method may be used in association with one or more portions of the method of FIG. 8. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method.

Referring to FIG. 9, at 902, the method may include transmitting information from the at least one RF identification token to a communication device.

In some embodiments, this may include presenting an RF identification token of the at least one RF identification token to the communication device. In some embodiments, this may include positioning the media 100 and/or the communication device such the RF identification token is within wireless communication range of the communication device. In some embodiments, this may include positioning the media 100 and/or the communication device such that the RF identification token is in physical contact with, and/or taps a portion of the communication device.

The communication device may recognize the RF identification token, and may transmit a signal to the RF identification token. In some embodiments, the signal may be transmitted via the antenna 416 (FIG. 4B) and may be similar to an interrogation signal of the above-mentioned “PayPass” standard.

The RF identification token may receive the signal transmitted by the communication device. In some embodiments, the signal may be received via the antenna 206 (FIG. 2) and may cause the RF identification token to be powered-up. For example, the proximity payment device may include circuitry to rectify the received request signal to generate DC power that may be used to power the control/storage circuitry 204 (FIG. 2) and transmit/receive circuitry 208 (FIG. 2).

In some embodiments, the RF identification token transmits the information in response to the interrogation signal. In some embodiments, the RF identification token may transmit the information via the antenna 206 (FIG. 2) after a handshake procedure or the like with the communication device.

At 904, the method may further include displaying at least a portion of the transmitted information on a display. In some embodiments, the communication device includes a display and displaying comprises displaying at least a portion of the transmitted information on the display of the communication device.

In some embodiments, the communication device informs and/or prompts the user using the display. In some embodiments, information supplied to and/or by the display comprises information supplied by the RF identification token.

In some embodiments, the communication device may transmit a request for additional information. The RF identification token may receive the request and may transmit additional information to the communication device. The communication device may receive the additional information. In some embodiments, this may be repeated until the communication device has received all the information stored in the RF identification token.

Thus, in some embodiments, it is possible to receive information from at least one RF identification token coupled to at least to sheet of a media.

In some embodiments, the communication device may store one or more portions of the data for subsequent retrieval. In some embodiments, the communication device may store one or more portions of the data for ordering and/or purchasing one or more of the plurality of products.

At 906, the method may further include transmitting information from the communication device. In some embodiments, the information may comprise at least a portion of the information transmitted from the at least one RF identification token.

In some embodiments, the information transmitted from the communication device includes information identifying a product. In some embodiments, the information transmitted from the communication device comprises at least one of: a name of a person, contact information for a person, and an account number.

In some embodiments, transmitting from the communication device comprises transmitting using at least one of: a telephone network; and a computer network. In some embodiments, transmitting information from the communication device comprises transmitting information from the communication device to at least one of: a supplier of the first product; and a party associated with the supplier of the first product.

If the communication device comprises a cell phone and/or other device coupled to a cellular network, the communication device may transmit the information via a communication link that includes the cellular network.

In some embodiments, the information is transmitted to a device operated by and/or on behalf of at least one of: a supplier of at least one of the plurality of products; and a party associated with the supplier of at least one of the plurality of products. In some embodiments, the device comprises a server. In some embodiments the device comprises a device coupled to a payment server. In some embodiments, the device comprises a server operating a website. In some embodiments, the device comprises a server coupled to a telephone network and/or the Internet.

In some embodiments, the information comprises an attempted order and/or purchase of at least one of the plurality of products. In some embodiments, the information may identify at least one product. In some embodiments, the information may include a payment account number. In some embodiments, the communication device may determine whether the attempted order and/or purchase was successful. If the attempted order and/or purchase was not successful, the communication device may inform the user that the attempted order and/or purchase was not successful. If the attempted order and/or purchase was successful, the communication device may inform the user that the attempted order and/or purchase was successful.

In some embodiments, the communication device may prompt the user to enter a user identifier (e.g., using a keypad). In some embodiments, the user enters a user identifier and the communication device determines whether the user identifier is valid. In some embodiments, the user identifier is transmitted to another device that determines whether the user identifier is valid. If the user identifier is not valid, the communication device may inform the user.

In some embodiments, one or more authentication protocols may be used in addition to and/or in lieu of the one or more portions of the methods disclosed herein.

The media 100 may be fabricated in any manner.

FIG. 10 shows a method for use in coupling at least one identification token to a sheet, in accordance with some embodiments.

Referring to FIG. 10, in accordance with some embodiments, a sheet, e.g., sheet 102, is provided. At least one adhesive layer 1000 may be disposed on at least one portion of the sheet 102. In some embodiments, each of the at least one adhesive layer 1000 is associated with a respective one of at least one identification token, e.g., the at least one identification token 170, and has a footprint that is the same as and/or similar to a footprint of the associated one of the at least one identification token 170. The at least one identification token 170 may be disposed on the at least one adhesive layer 1000.

In some embodiments, at least one shield 1002 is disposed between the sheet 102 and the at least one identification token 170. In some embodiments, each of the at least one shield 1002 is associated with a respective one of the at least one identification token and has a footprint that is the same as and/or similar to a footprint of the associated one of the at least one identification token 170. In some other embodiments, the at least one shield 1002 comprises a single shield that may be the same size as the sheet 102.

The at least one shield 1002 may help to electromagnetically decouple the circuitry and/or antenna of the at least one identification token 170 from other structures and/or devices. In some embodiments, for example, a user may position the sheet 102 on a structure and/or a device with a metal body. Without shielding, such metal body could effect frequencies and/or magnitudes of signals to be received and/or transmitted by the at least one identification token 170. The at least one shield 1002 may help prevent such signals from being loaded down by such metal body. In some embodiments, the at least one shield 1002 may also provide shielding from any electromagnetic signals transmitted by other devices. In some embodiments, the at least one shield 1002 may also help prevent signals from one or more of the at least one identification token from interfering with signals from one or more other ones of the at least one identification token. In some embodiments, the at least one shield 1002 may comprise ferrite and/or other material.

In some embodiments at least one non-conductive layer (not shown) is disposed between the at least one shield 1002 and the at least one identification token 170. In some embodiments, each of the at least non-conductive layer is associated with a respective one of the at least one identification token 170 and has a footprint that is the same as and/or similar to a footprint of the associated one of the at least one identification token 170. The at least one non-conductive layer may help electrically insulate the at least one shield 1002 from the at least one identification token 170 and/or other layers or devices. In some embodiments the at least one non-conductive layer comprises a non-conductive adhesive material.

The information may be stored in the at least one RF identification token 170 before, during and/or after coupling the at least one RF identification token 170 to the at least one sheet 102. In some embodiments, all of the information is stored in the at least one identification token 170 before coupling the at least one RF identification token 170 to the at least one sheet 102. In some other embodiments, all of the information is stored in the at least one RF identification token 170 after coupling the at least one RF identification token 170 to the at least one sheet 102.

The information printed on the at least one sheet 102 may be printed before during and/or after coupling the at least one RF identification token 107 to the at least one sheet 102. In some embodiments, all of the information is printed on the at least one sheet 102 before coupling the at least one RF identification token 170 to the at least one sheet 102. In some other embodiments, all of the information is printed on the at least one sheet 102 after coupling the at least one RF identification token 170 to the at least one sheet 102.

FIG. 11 shows a method for use in coupling at least one identification token to a sheet, in accordance with some embodiments.

Referring to FIG. 11, in accordance with some embodiments, a first layer 1100 of a sheet, e.g., sheet 102, and a second layer 1102 of the sheet are provided. In some embodiments, the first layer 1100 and the second layer 1102 each have a generally rectangular configuration. At least one identification token, e.g., at least one identification token 170, may be provided and disposed on one of the major outer surfaces of the first layer 1100. In some embodiments, the at least one identification token is provided as part of a third layer 1104. In such embodiments, the third layer 1104 may be disposed on the major outer surface of the first layer 1100. The second layer 1102 may be disposed on the at least one identification token and/or the third layer 1104, if provided. The outer edges of the second layer 1102 may be disposed in register with the outer edges of the first layer 1100 and the outer edges of the third layer 1104, if provided.

Heat and/or pressure may be applied. The heat and/or pressure may cause the first layer 1100 and the second layer 1102 to become bonded to one another so as to trap the at least one identification token 170.

In some embodiments, at least one shield 1106 is disposed between the first layer 1100 and at least one identification token 170. In some embodiments, each of the at least one shield 1106 is associated with a respective one of the at least one identification token and has a footprint that is the same as and/or similar to a footprint of the associated one of the at least one identification token 170. In some other embodiments, the at least one shield 1106 comprises a single shield that may be the same size as the first layer 1000.

The at least one shield 1106 may help to electromagnetically decouple the circuitry and/or antenna of the at least one identification token 170 from other structures and/or devices. In some embodiments, for example, a user may position the sheet on a structure and/or a device with a metal body. Without shielding, such metal body could effect frequencies and/or magnitudes of signals to be received and/or transmitted by the at least one identification token 170. The at least one shield 1106 may help prevent such signals from being loaded down by such metal body. In some embodiments, the at least one shield 1106 may also provide shielding from any electromagnetic signals transmitted by other devices. In some embodiments, the at least one shield 1106 may also help prevent signals from one or more of the at least one identification token 170 from interfering with signals from one or more others of the at least one identification token 170. In some embodiments, the at least one shield 1106 may comprise ferrite and/or other material.

In some embodiments at least one non-conductive layer (not shown) is disposed between the at least one shield 1106 and the at least one identification token 170. In some embodiments, each of the at least non-conductive layer is associated with a respective one of the at least one identification token 170 and has a footprint that is the same as and/or similar to a footprint of the associated one of the at least one identification token 170. The at least one non-conductive layer may help electrically insulate the at least one shield 1106 from the at least one identification token 170 and/or other layers or devices. In some embodiments the at least one non-conductive layer comprises a non-conductive adhesive material.

The at least one identification token 170 are not limited to the configuration (e.g., number, size and/or shape) and/or positioning shown. Rather, the at least one identification token 170 may have any configuration and positioning.

FIG. 12 is a perspective view of a media 100, in accordance with some embodiments. Referring to FIG. 12, in some embodiments, the at least one RF identification token 170 includes the first RF identification token 180. The first RF identification token 180 may be disposed at a first position 190.

In accordance with some embodiments, the first RF identification token 180 includes information regarding a plurality of products. In some embodiments, the first RF identification token 180 includes information regarding the first product and the second product. The information may include information not included in the first printed region and/or the second printed region.

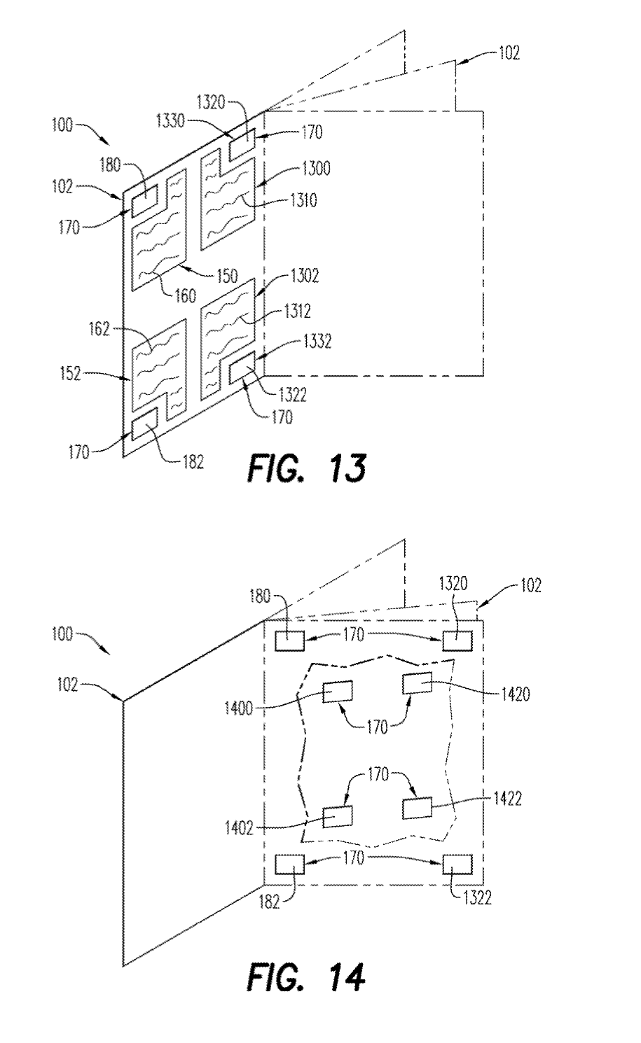

FIG. 13 is a perspective view of a media 100, in accordance with some embodiments. Referring to FIG. 13, in some embodiments, the plurality of printed regions includes a first printed region 150, a second printed region 152, a third printed region 1300 and a fourth printed region 1302. The first printed region 150 may include first printing 160. The second printed region 152 may include second printing 162. The third printed region 1300 may include third printing 1310. The fourth printed region 1302 may include fourth printing 1312.

In some embodiments, the first printed region 150 includes an advertisement and/or other information regarding a first product. The second printed region 152 may include an advertisement and/or other information regarding a second product. The third printed region 1300 may include an advertisement and/or other information regarding a third product. The fourth printed region 1302 may include an advertisement and/or other information regarding a fourth product.

In some embodiments, the at least one RF identification token 170 includes a first RF identification token 180, a second RF identification token 182, a third RF identification token 1320 and a fourth RF identification token 1322.

In some embodiments, the first RF identification token 180 includes information regarding the first product. The information may include information not included in the first printed region. The second RF identification token 182 may include information regarding the second product. The information may include information not included in the second printed region. The third RF identification token 1320 may include information regarding the third product. The information may include information not included in the third printed region. The fourth RF identification token 1322 may include information regarding the fourth product. The information may include information not included in the fourth printed region.

The first RF identification token 180 may be disposed at a first position 190. The second RF identification token 182 may be disposed at a second position 192. The third RF identification token 1320 may be disposed at a third position 1330. The fourth RF identification token 1322 may be disposed at a fourth position 1332.

In some embodiments, the first position 190 is adjacent a first corner of a page. The second position 192 may be adjacent a second corner of the page. The third position 1330 is adjacent a third corner of the page. The fourth position 1332 is adjacent a fourth corner of the page

In some embodiments, increasing distances between adjacent ones of the at least one RF identification token 170 helps prevent ones of the at least one RF identification token from interfering with adjacent ones of the at least one RF identification token.

FIG. 14 is a perspective, partially broken away view of a media 100, in accordance with some embodiments.

Referring to FIG. 14, in some embodiments, the at least one RF identification token 170 further includes a fifth RF identification token 1400, a sixth RF identification token 1402, a seventh RF identification token 1420 and an eighth RF identification token 1422.

In some embodiments, the positions of one or more RF identification tokens 180, 182, 1320, 1322 on one page may be offset from the positions of one or more RF identification tokens 1400, 1402, 1420, 1422 on another page.

In some embodiments, this may help prevent the one or more RF identification tokens 180, 182, 1320, 1322 on one page from interfering with the one or more RF identification tokens 1400, 1402, 1420, 1422 on another page.

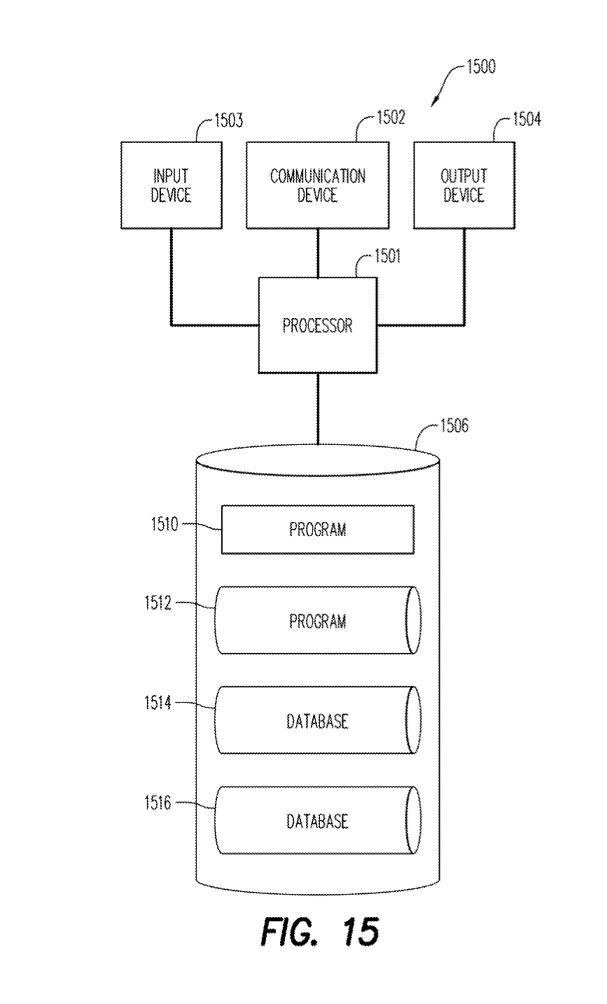

FIG. 15 is a block diagram of an apparatus 1500 according to some embodiments. In some embodiments, one or more of the devices (or portion(s) thereof) disclosed herein may have an architecture that is the same as and/or similar to one or more portions of the architecture of apparatus 1500.

Referring to FIG. 15, in accordance with some embodiments, the apparatus 1500 includes a processor 1501 operatively coupled to a communication device 1502, an input device 1503, an output device 1504 and a storage device 1506.

In some embodiments, the processor 1501 may execute processor-executable program code to provide one or more portions of the one or more functions disclosed herein and/or to carry out one or more portions of one or more embodiments of one or more methods disclosed herein. In some embodiments, the processor 1501 may be a conventional microprocessor or microprocessors.

The communication device 1502 may be used to facilitate communication with other devices and/or systems. In some embodiments, communication device 1502 may be configured with hardware suitable to physically interface with one or more external devices and/or network connections. For example, communication device 1502 may comprise an Ethernet connection to a local area network through which apparatus 1500 may receive and transmit information over the Internet and/or one or more other network(s).

The input device 1503 may comprise, for example, one or more devices used to input data and/or other information, such as, for example: a keyboard, a keypad, track ball, touchpad, a mouse or other pointing device, a microphone, knob or a switch, an infra-red (IR) port, etc. The output device 1504 may comprise, for example, one or more devices used to output data and/or other information, such as, for example: an IR port, a docking station, a display, a speaker, and/or a printer, etc.

The storage device 1506 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 1506 may store one or more programs 1510-1512, which may include one or more instructions to be executed by the processor 1501.

In some embodiments, the one or more programs may include one or more operating systems, database management systems, other applications, other information files, etc., for operation of the apparatus 1500.

The storage device 1506 may store one or more databases 1514-1516 and/or criteria for one or more programs. As used herein a “database” may refer to one or more related or unrelated databases. Data and/or other information may be stored in any form. In some embodiments, data and/or other information may be stored in raw, excerpted, summarized and/or analyzed form.

In some embodiments, the communication device 400 may also operate as a proximity payment device. In some such embodiments, such proximity payment device may operate in a conventional manner, e.g., in accordance with the above-mentioned “PayPass” standard. For example, the proximity payment device may be presented to a proximity coupling device (not shown) of a POS terminal (not shown) to accomplish payment for a sales transaction. The proximity coupling device may transmit an interrogation signal. The proximity payment device may receive the interrogation signal via the antenna 416 (FIG. 4B). The received interrogation signal may cause the circuitry of the proximity payment device to be powered-up. For example, the proximity payment device may include circuitry to rectify the received interrogation signal to generate a DC power that may be used to power the control/storage circuitry 414 (FIG. 4B) and transmit/receive circuitry 418 (FIG. 4B). The proximity payment device may transmit a signal to the proximity coupling device in response to the interrogation signal. The proximity payment device may transmit the signal (and possibly one or more additional signals) to the proximity coupling device via the antenna 416 (FIG. 4B). One or more signals transmitted by the proximity payment device may include a payment card account number and/or other information required for interaction with the proximity coupling device. In some embodiments, the proximity payment device may transmit the payment card account number and/or other information via the antenna 416 (FIG. 4B) after a handshake procedure or the like with the POS terminal. The POS terminal may then interact with a payment card system to charge the current sales transaction to the payment card account represented by the payment card account number received from the proximity payment device.

In some embodiments, the proximity payment device may be enabled at all times. In some other embodiments, the proximity payment device may be enabled only at selected times. In some embodiments, a proximity payment device may be selectively enabled/disabled in order to enable and/or disable operation of the proximity payment device. In some embodiments, an input device may be provided to selectively enable operation of the proximity payment device. In some embodiments, a proximity payment device may be presented to a proximity coupling device before, during and/or after enabling operation of the proximity payment device.

In some embodiments, the communication device may transmit a payment account number (sometimes referred to herein as a “PAN”) that directly identifies a payment card account. In some embodiments, the communication device may transmit a proxy or surrogate account number that does not, on its own, directly identify a payment card account. Instead, the proxy or surrogate account number (otherwise referred to, in the context of a MasterCard-branded payment card, as a “PayPass PAN” or “PPAN”) is translated into a PAN (e.g., during a payment transaction by a payment network or an issuer) for use in completing a transaction.

In some embodiments, one or more portions of one or more embodiments disclosed herein may be embodied in a method, an apparatus, a computer program product, and/or a storage medium readable by a processing system.

As used herein, a signal may be any type of signal, i.e., a physical quantity (e.g., voltage, current, or magnetic field strength), an indication, a message and/or any other type of signal or combination thereof. A voltage, current, or magnetic field strength may be analog, digital, single ended signal, differential and/or any other type or combination thereof.

A wireless communication interface may be any type of wireless communication interface.

As used herein, a controller may be any type of controller. For example, a controller may be programmable or non programmable, general purpose or special purpose, dedicated or non dedicated, distributed or non distributed, shared or not shared, and/or any combination thereof. If the controller has two or more distributed portions, the two or more portions may communicate with one another through a communication link. A controller may include, for example, but is not limited to, hardware, software, firmware, hardwired circuits and/or any combination thereof.

A circuit may be programmable or non programmable, general purpose or special purpose, dedicated or non dedicated, distributed or non distributed, shared or not shared, and/or any combination thereof. If the circuit has two or more distributed portions, the two or more portions may communicate with one another through a communication link. A circuit may include, for example, but is not limited to, hardware, software, firmware, hardwired circuits and/or any combination thereof.

As used herein, the term “proximity payment device” refers to any device, of any shape, which transmits to a point of sale terminal, by wireless transmission, a payment account number. As used herein, a payment account number may be numeric, non numeric and/or a combination thereof.

In some embodiments, a proximity payment device may also have a contact interface like that of a conventional smart card that includes a contact interface.

In some embodiments, one or more logos and/or brands, including for example the brand/logo of a national and/or international payment card association such as MasterCard International Incorporated, may be provided on one or more surfaces of a proximity payment device. The brand/logo of the issuer may also be provided, as well as, for example, a specific card product brand. Embossed or non-embossed numbers and/or letters may be provided on the proximity payment device to indicate one or more account numbers and/or a name of an account holder. Other features that may be provided on the proximity payment device are an adhesive paper strip to receive the signature of the cardholder, and a security code or the like printed on the adhesive strip. In addition, the proximity payment device may have one or more magnetic stripes to allow the proximity payment device to be read by a magnetic card reader.

Some of the principles taught herein have heretofore been described in the context of proximity payment devices. Nevertheless, these teachings are also applicable to a transportation related device; an identification device to identify the holder for purposes apart from or in addition to transaction payments (e.g., to identify medical patients and/or individuals insured by health insurance plans); a device used to portably store medical record information; stored value card(s); and to so-called electronic passports (also known as RFID-enabled passports) and/or a source of any type of information associated with a holder (and/or the holder of the card installed therein).

The term “transportation related device” refers to a card or other device used to pay, or confirm or evidence payment of, a charge for using a transportation system and/or cards or the like issued by transportation systems (e.g., mass transit systems) for access to the transportation systems. The term “RFID-enabled passport” refers to an internationally recognized travel document that includes an IC and an antenna and communicates with a terminal by a wireless communication technique. The term “information” may include but is not limited to a name, a social security number, an account number, an expiration date, a security code and/or medical information.

As used herein, an account number may be numeric, non numeric and/or a combination thereof.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method comprising:
providing a media including a plurality of coupled pages, the plurality of coupled pages including at least one printed page defined by at least one printed sheet;
coupling at least one RF identification token to the at least one printed sheet; and
storing information in the at least one RF identification token, the information including information regarding a plurality of products.

2. The method of claim 1 wherein the media comprises at least one of a brochure, a menu, a magazine, a newspaper, a catalogue and a book.

3. The method of claim 1 wherein the at least one printed sheet includes information identifying the plurality of products and wherein the information stored in the at least one RF identification token includes additional information regarding the plurality of products.

4. The method of claim 1 wherein coupling at least one identification token to the at least one printed sheet comprises:
coupling a first RF identification token to the at least one printed sheet; and
coupling a second RF identification token to the at least one printed sheet;
wherein storing information in the at least one RF identification token comprises:
storing information in the first RF identification token; and
storing information in the second RF identification token; and
wherein the information stored in the first RF identification token is different than the information stored in the second RF identification token.

5. The method of claim 1 wherein the information comprises at least 100 kilobytes of information.

6. The method of claim 1 further comprising:
transmitting information from the at least one RF identification token to a communication device, the transmitted information comprising at least a portion of the information stored in the at one RF identification token.

7. The method of claim 6 wherein the communication device comprises a display, the method further comprising:
displaying at least a portion of the transmitted information on the display.

8. The method of claim 7 wherein the communication device comprises a cellular telephone.

9. The method of claim 6 further comprising transmitting information from the communication device in response at least in part to the information transmitted from the at least one RF identification token, and wherein transmitting information from the communication device comprises transmitting information from the communication device using at least one of the following:
a telephone network; and
a computer network.

10. The method of claim 9 wherein the information transmitted from the communication device comprises at least one of:
a name of a person;
contact information for a person; and
an account number.

11. The method of claim 9 wherein the information transmitted from the communication device comprises information identifying a first product of the plurality of products.

12. The method of claim 11 wherein transmitting information from the communication device comprises transmitting information from the communication device to at least one of the following:
a supplier of the first product; and
a party associated with the supplier of the first product;
wherein the method further comprises receiving by the communication device, information from at least one of the following:
a supplier of the first product; and
a party associated with the supplier of the first product.

13. Apparatus comprising:
a media including a plurality of coupled pages, the plurality of coupled pages including at least one printed page defined by at least one printed sheet; and
at least one RF identification token coupled to the at least one printed sheet, the at least one RF identification token including stored information regarding a plurality of products.

14. The apparatus of claim 13 wherein the media comprises at least one of a brochure, a menu, a magazine, a newspaper, a catalogue and a book.

15. The apparatus of claim 13 wherein the at least one printed sheet includes information identifying the plurality of products and wherein the information stored in the at least one RF identification token includes additional information regarding the plurality of products.

16. The apparatus of claim 13 wherein the at least one identification token comprises:
a first RF identification token coupled to the at least one printed sheet; and
a second RF identification token coupled to the at least one printed sheet;
wherein the first RF identification token includes stored information, the second RF identification token includes stored information, and the information stored in the first RF identification token is different than the information stored in the second RF identification token.

17. The apparatus of claim 13 wherein the information comprises at least 100 kilobytes of information.

18. The apparatus of claim 13 further comprising:
a communication device;
wherein the at least one RF identification token transmits information to the communication device, the transmitted information comprising at least a portion of the information stored in the at one RF identification token.

19. The apparatus of claim 18 wherein the communication device displays at least a portion of the information transmitted by the at least one RF identification token.

20. The apparatus of claim 19 wherein the communication device comprises a cellular telephone.
